(19) United States
(12) Patent Application Publication
(10) Pub. No.: US 2003/0206782 A1
(43) Pub. Date: Nov. 6, 2003

(54) Flexible cargo restraints

(76) Inventor: Neal C. Toglia, Wayne, NJ (US)

Correspondence Address: NEAL C. TOGLIA, 27 WHITTAKER CT., WAYNE, NJ, 07470, US

(21) Appl. No.: 10/135,027

(22) Filed: May 1, 2002

(51) Int. Cl. B60P 1/64

(52) U.S. Cl. 410/94

(57) ABSTRACT

An easy to use cargo restraining barrier device designed to keep fragile or spillable items in a vehicle's trunk or cargo area from sliding or tipping during transport. This versatile device is comprised of a length of flexible material of any cross-sectional shape that will fit snuggly against cargo and restrain it from undesirable movement. This barrier device is placed in position by the user to restrain cargo and is secured to trunk or cargo area carpet via Velcro hook-type pads bonded at intervals to the barrier's underside. The versatility of this device is derived from its flexible construction and its ability to conform to the various shapes of cargo items which is a distinct advantage over prior art. The simplicity of construction of this device offers potential economic advantages in cost to manufacture over prior art.

### CROSS REFERENCE TO RELATED APPLICATIONS

Not Applicable

### FEDERALLY SPONSORED RESEARCH OR DEVELOPMENT

Not Applicable

### SEQUENCE LISTING, A TABLE, OR A COMPUTER PROGRAM LISTING, COMPACT DISK APPENDIX

Not Applicable

### BACKGROUND OF INVENTION

1. Field of the Invention

This invention relates to devices for restraining containers, packages or other items of cargo in the trunk or cargo area of vehicles and more particularly relates to restraint devices comprising flexible barriers that, when arranged to secure items of cargo, will prevent moving and tipping during transport in cargo areas of vehicles.

2. Background Information

Transportation of cargo in the trunks or cargo areas of vehicles is often difficult because of the fragile nature or possible spilling of contents of containers if not secured to prevent undesirable movement of these cargo items during transportation. Fragile items can impact other items being carried or impact trunk or cargo area walls and become damaged and containers can tip and spill contents.

There is a particular problem of adequately securing cargo against movement because of the wide variety of shapes and sizes of packages, containers and objects to be transported. Prior art available consists of vertical walled barrier devices that either unfold from a device to form fixed compartments of varying size to restrain cargo or vertical walled barriers of rigid material that adhere to trunk or cargo area surfaces via mechanical or magnetic means. The problem with these various systems is their failure to conform to the various shapes of cargo because these devices form vertical barrier walls only and are inflexible in forming barriers to secure cargo by fitting snuggly against the items of cargo regardless of shape. It would be desirable if restraining barriers or devices could be easily arranged to fit more snuggly than the prior art against the exteriors of cargo of various shapes and sizes and to restrain movement adequately to prevent undesirable sliding or tipping.

It is, therefore, one object of the present invention to provide a cargo restraining barrier of flexible composition that can be easily arranged to restrain packages, containers or other objects of various sizes and shapes being transported in the cargo areas of vehicles.

Yet another object of the present invention is to provide a cargo restraining barrier that can be secured, in various configurations conforming to cargo shape and size, to trunk or cargo areas of vehicles because of its inherent flexible construction and having Velcro hook-type material bonded securely to its underside for gripping to carpeted area.

Still another object of the present invention is to provide a cargo restraining barrier that is comprised of various cross-sectional shapes to form curved, vertical-straight or angled-straight walls for contact with and restraint of packages, containers and other cargo items of varying shapes.

Yet another object of the present invention is to provide a cargo restraining barrier that can be manufactured in any length and can be easily cut by the user into shorter lengths for application in various configurations in trunk or cargo areas.

Still another object of the present invention is to provide a cargo restraining device very simple in construction thus being inexpensive to manufacture.

### BRIEF SUMMARY OF INVENTION

The general idea of the present invention is to provide a cargo restraining barrier device that can be conveniently used to restrain and secure cargo such as articles that are fragile or that may tip and spill contents when being transported in automobile trunks or other vehicular cargo areas. This device can be provided in various lengths, cross-sectional shapes and sizes and would grip to the trunk or cargo area carpet surface via Velcro hook-type material bonded to its underside. The device would be positioned such that it surrounds and entraps a cargo item being transported and secures it from sliding or tipping during transport.

This invention solves problems represented by prior art in that other available systems form rigid vertical barrier walls to restrain cargo while this invention forms curved or straight walls and is comprised of flexible, bendable material that can be placed in use to fit snuggly against the perimeter walls, surfaces or edges of cargo. A vertical walled barrier of rigid construction as in prior art cannot stabilize an item such as a bowl, casserole dish, or any container with non-vertical side walls. The present invention can restrain such containers via a curved wall embodiment or a triangular cross-sectional embodiment applied in contact snuggly against the side walls of non-vertical walls of the article.

This invention comprises devices of flexible material of various lengths, sizes and any cross-sectional shapes such as circular, oval, square, rectangular, triangular, but not limited to these shapes, with Velcro hook-type material bonded to the underside at intermittent spacing for purposes of gripping to carpet lined cargo areas of vehicles. These devices can be constructed of any flexible material such as rubber, foam rubber, plastic, extruded foam plastic such as standard water pipe insulation, and can be solid, hollow, tubular, with smooth or ribbed exterior surface to enhance flexibility and bending to fit snuggly against or around cargo of various shapes and sizes.

The above and other unique and novel features of the invention will be more completely understood from the following detailed description and accompanying drawings.

### BRIEF DESCRIPTION OF THE DRAWINGS

FIG. 1 is a perspective view illustrating a cargo restraining flexible barrier constructed according to the present invention in a first embodiment and a sectional view taken at 1-1;

FIG. 2 is a perspective view of a second embodiment of a cargo restraining flexible barrier constructed according to the present invention and a sectional view taken at 2-2.;

FIG. 3 is a perspective view of a third embodiment of a cargo restraining flexible barrier constructed according to the present invention and a sectional view taken at 3-3;

FIG. 4 is a perspective view of a cargo restraining flexible barrier showing a variation of the embodiment of FIG. 1; and

FIG. 5 is a partial section of a vehicle cargo area illustrating use of the cargo restraining flexible barrier.

### DETAILED DESCRIPTION OF THE INVENTION

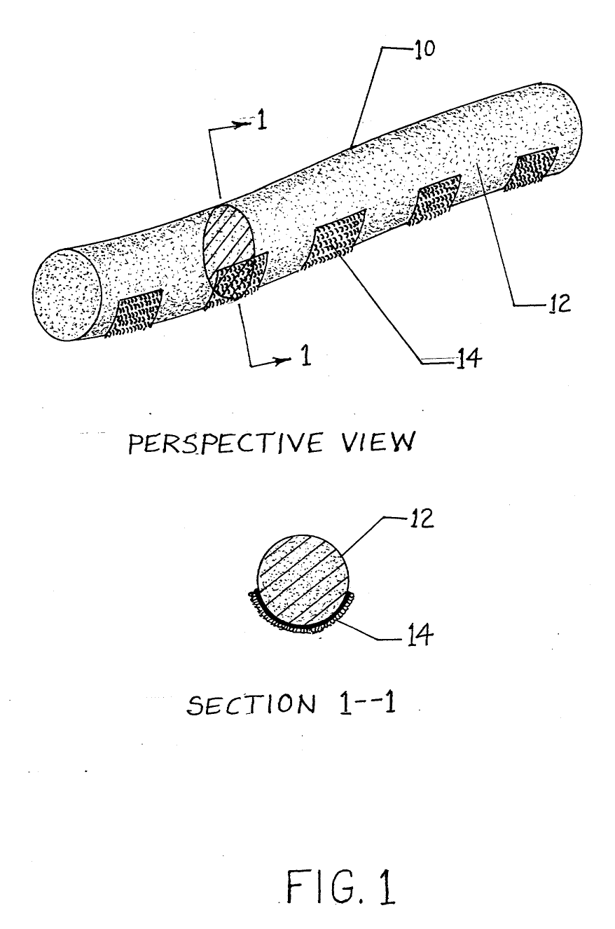

A preferred embodiment of a cargo restraining flexible barrier constructed according to the invention is illustrated in FIG. 1. The cargo restraint flexible barrier 10 is constructed to provide a curved restraining wall 12. Preferably, cargo restraining flexible barrier 10 is made of a formed or extruded foam rubber or foam plastic construction similar to standard water pipe insulation. However, any material of adequate flexibility may comprise construction.

Gripping pads 14 are provided firmly bonded to the underside to hold cargo restraint flexible barrier 10 in place. Gripping surfaces 14 are provided at intermittent spacing along the underside of cargo restraint flexible barrier 10. Preferably Velcro-type hook material pads comprise the gripping pads 14 with hook elements facing outward and smooth backing material bonded firmly to the cargo restraint flexible barrier 10 by adhesive or by other mechanical or chemical bonding methods that will accommodate the bending of cargo restraint flexible barrier 10 into various configurations when in use.

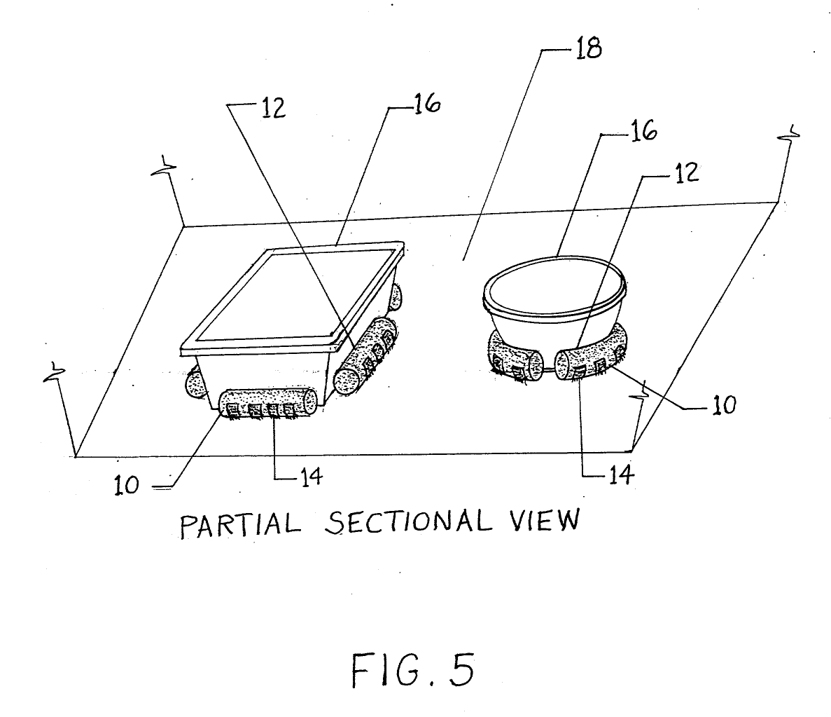

A partial sectional view of a cargo area with cargo restraining flexible barriers in position to hold containers 16 in place is illustrated in FIG. 5. The partial section of FIG. 5 illustrates a carpeted cargo area 18 typically found in the trunk of an automobile. Cargo area 18 illustrates the floor area of a trunk that has carpeted floor 18. Cargo restraint flexible barriers are positioned on the carpeted floor 18, Velcro-type gripping pads 14 engaged with carpeted floor 18 to form restraining barriers with curved wall 12 fitting snuggly against the walls of containers 16. Containers 16 are secured by placement of cargo restraint flexible barriers 10 in positions to surround or entrap containers 16 such that undesired sliding, tipping or movement is prevented.

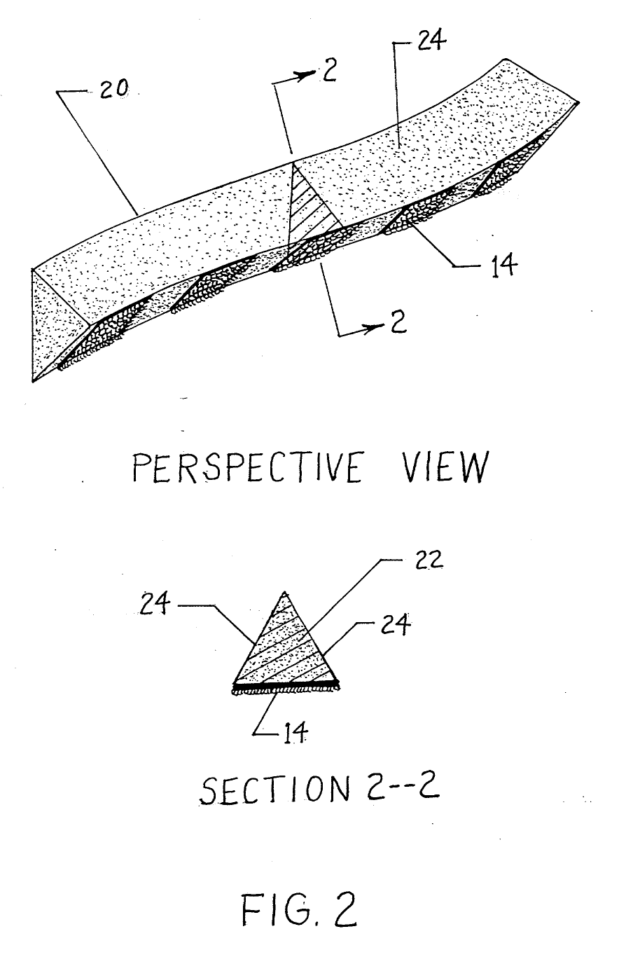

A second embodiment of the present invention is illustrated in FIG. 2. In this embodiment cargo restraining flexible barrier 20 is in the form of triangular cross-section 22. This embodiment results in straight restraining walls 24 angled at various degrees from vertical by manufacture of triangular shape. This embodiment is again constructed of a suitable flexible material with gripping pads 14 bonded to the underside at intermittent spacing.

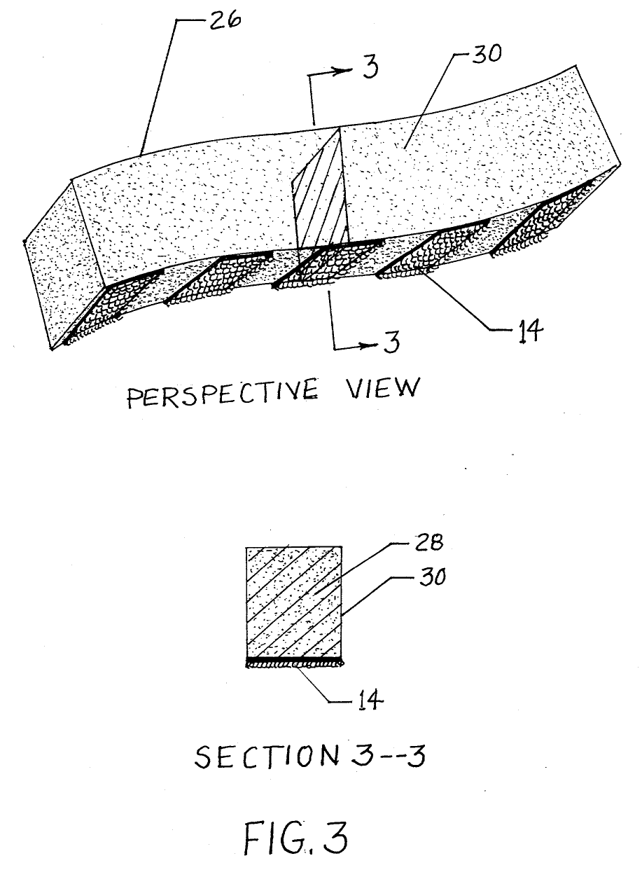

A third embodiment of the present invention is illustrated in FIG. 3. In this embodiment cargo restraining flexible barrier 26 is in the form of rectangular or square cross-section 28. This embodiment results in straight vertical restraining walls 30 when in use and is again constructed of a suitable flexible material with griping pads 14 bonded to the underside at intermittent spacing.

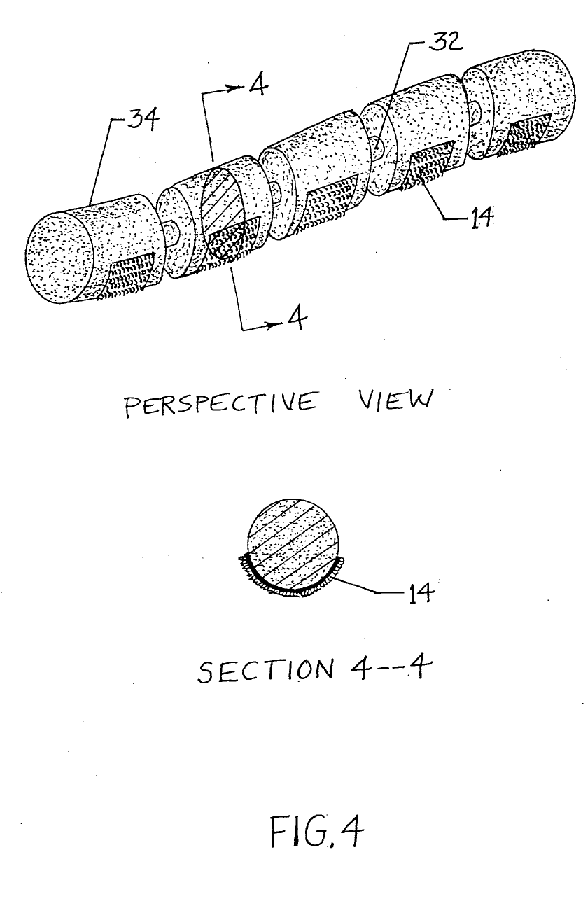

A variation of the embodiment of FIGS. 1 through 3 is illustrated in FIG. 4. This design reduces the material needed for construction and increases flexibility by providing ribs 32 at intermittent spacing along the length of the cargo restraining flexible barrier 34. Velcro hook gripping pads 14 are excluded from the ribbed sections of this embodiment. An additional variation to reduce material may provide a hollow core construction. Still another variation may include a surface coating or material applied to the exterior surfaces to enhance friction with and gripping of smooth cargo surfaces such as glass or plastic.

Thus, there has been disclosed a cargo restraining flexible barrier that is simple in construction, flexible in application and easy to use and store when not in use. In the first embodiment the cargo restraining flexible barrier is formed of a flexible material in a circular, oval, elliptical, or any curved cross-sectional shape and of any length, providing a barrier with curved restraining wall, having Velcro hook-type pads bonded to its underside to firmly hold the cargo restraining flexible barrier in place when restraining containers, packages or any cargo in the carpeted trunk or cargo area of a vehicle. In several optional embodiments, the barrier is formed in various cross-sectional shapes such as triangular, rectangular or square shapes but further embodiments may include any cross-sectional shape. A variation of the optional embodiments includes a hollow core construction and a ribbed construction to save material and enhance flexibility. The embodiments of the present invention may be manufactured at any size or length. The distinct advantage and improvement of this invention over prior art is simplicity of construction and low cost of manufacture as well as its versatile application in use. It can easily be formed in place to fit snuggly against the widely varying shapes of cargo containers and packages, thus more securely restraining cargo from movement than other prior art comprised of rigid components and fixed component lengths.

This invention is not to be limited by the embodiment shown in the drawings and described in the description which is given by way of example and not of limitation, but only in accordance with the scope of the appended claims.

What is claimed is:

1. A cargo restraining flexible barrier device comprising;
a barrier means;
said barrier means formed to any length and various cross-sectional shapes;
said barrier means to be constructed with circular, oval, elliptical, triangular, square, rectangular, trapezoidal and any other symmetrical or asymmetrical geometric cross-sectional shape; gripping means on the underside of said barrier;
said barrier means to be constructed to allow flexibility and ease of bending lengthwise at any point along its length;
frictional means on the exterior surfaces of said barrier means;
whereby a single length of said cargo restraining flexible barrier positioned around containers, packages or any cargo being transported will firmly secure and hold said cargo from sliding or tipping;
whereby a plurality of said cargo flexible restraining barriers positioned around containers, packages or any cargo being transported will firmly secure and hold said cargo from sliding or tipping.

2. The device according to claim 1 in which gripping means comprises Velcro hook-type material bonded to the underside of said barrier means.

3. The device according to claim 2 in which said gripping means are intermittently spaced along the underside of said barrier means.

4. The device according to claim 1 in which said frictional means comprises a formed finish or chemical coating applied to the exterior surfaces of said barrier means.

5. The device according to claim 1 in which said barrier means comprises a ribbed construction, with ribs being intermittently spaced.

6. The device according to claim 1 in which said barrier means comprises a solid shape of homogeneous or composite material.

7. The device according to claim 1 in which said barrier means comprises a hollow core shape of homogeneous or composite material.
